(19) United States
(12) Patent Application Publication
(10) Pub. No.: US 2023/0243859 A1
(43) Pub. Date: Aug. 3, 2023

(54) Systems and Methods for Loading Reagent-Containing Microfluidic Chips Having Single-Use Valves

(71) Applicant: Pattern Bioscience, Inc., Austin, TX (US)

(72) Inventor: Chueh-Yu WU, Austin, TX (US)

(73) Assignee: Pattern Bioscience, Inc., Austin, TX (US)

(21) Appl. No.: 18/054,326

(22) Filed: Nov. 10, 2022

Related U.S. Application Data
(60) Provisional application No. 63/277,945, filed on Nov. 10, 2021.

(51) Int. Cl. G01N 35/08; B01L 3/00

(52) U.S. Cl. CPC G01N 35/08; B01L 3/502784; B01L 3/502738; B01L 2300/0861; B01L 2200/16

(57) ABSTRACT

A microfluidic chip can include a microfluidic network that comprises a port, one or more test volumes, and one or more channels through which fluid must flow from the port to the test volume(s). A crosslinkable material can also be disposed within the microfluidic network such that the crosslinkable material is flowable through the channel(s). The crosslinkable material of the microfluidic chip may be exposed to light and/or heat to crosslink the material within and thereby occlude the channel(s). A method of loading the microfluidic chip can include disposing a liquid within a port of a microfluidic network that includes one or more test volumes and one or more channels; flowing each of one or more portions of the liquid from the port, through at least one of the channel(s), and into a respective one of the test volume(s); and directing a crosslinkable material into at least one of the channel(s) and cross-linking the crosslinkable material such that none of the test volume(s) are in fluid communication with the port when the portion(s) of the liquid are in the test volume(s).

### CROSS-REFERENCE TO RELATED APPLICATIONS

The present application claims the benefit of priority to U.S. Application No. 63/277,945, filed Nov. 10, 2021. The contents of the referenced application are incorporated herein by reference in their entirety.

### FIELD OF INVENTION

The present invention relates generally to loading microfluidic chips and, specifically, to loading microfluidic chips having single-use valves for reagent testing.

### BACKGROUND

Microfluidic chips have gained increased use in a wide variety of fields, including cosmetics, pharmaceuticals, pathology, chemistry, biology, and energy. A microfluidic chip typically has one or more channels that are arranged to transport, mix, and/or separate one or more samples for analysis thereof. At least one of the channel(s) can have a dimension that is on the order of a micrometer or tens of micrometers, permitting analysis of comparatively small (e.g., nanoliter or picoliter) sample volumes. The small sample volumes used in microfluidic chips provide a number of advantages over traditional benchtop techniques. For example, more precise biological measurements, including the manipulation and analysis of single cells and/or molecules, may be achievable with a microfluidic chip due to the scale of the chip's components. Microfluidic chips can also provide improved control of the cellular environment therein to facilitate experiments related to cellular growth, aging, antibiotic resistance, and the like. And microfluidic chips, due to their small sample volumes, low cost, and disposability, are well-suited for diagnostic applications, including identifying pathogens and point-of-care diagnostics.

In some applications, microfluidic chips are configured as integrated fluidics networks for multiplexing applications, such as in vitro diagnostic products (IVDs) for infectious diseases, IVDs for cancer, organs-on-chips, multiplexing PCR, multiplexing ELISA, capillary ELISA, gene sequencing (e.g., single-cell gene sequencing), genetic synthesis for pharmaceutical products (e.g., personalized medicine), multiplexing flow cytometry, primary cell sorting, T-cell sorting for therapy, algae sorting for green energy, and cell secretion assays (e.g., single-cell secretion assays). For example, it can be valuable to test the impact of multiple reagents on a sample. For example, for antibiotic susceptibility testing, testing multiple antibiotics individually in a multiplexed manner may allow the selection of an antibiotic most effective at inhibiting microbe growth to treat an infection. Traditionally, such testing is performed by placing different reagents in individual wells of a test apparatus and introducing a portion of the sample into each of the wells manually using a pipette or with a robot. However, such a process is susceptible to errors and can be expensive and complex.

Microfluidic chips configured for multiplexing applications can streamline this process and offers the advantages of reduced biological sample and reagent volume, speedup and simplification of diagnostic processing, and reduced diagnostic errors from sample contamination. Traditionally, for multiplexing applications where the number of reaction chambers on the chips are maximized, microvalves are utilized to isolate individual fluidic reactions or operations. In particular, microvalves are manipulated between an open position in which a fluidic sample dispensed at or pumped to an inlet of the chip flows into the reaction chambers of the chip and a closed position in which the reaction chambers are sealed off from one another to allow multiplexing of isolated and independent reactions, diagnoses, and/or product production in the individual chambers.

Several types of microvalves having different mechanisms of action for isolating fluidic networks or reaction chambers have been described previously, including electrostatic, electrochemical, piezoelectric, magnetic, electromagnetic, and gas actuation valves. Electrostatic microvalves are applied using electrostatic force on electrodes to move a flexible membrane to close the valve. Electrochemical microvalves utilize a hydrogen bubble generated by electrolyzing solution to actuate a membrane to close the valve. A piezoelectric microvalve transforms an electrical signal to a bending force to displace a membrane. Magnetic microvalves are built using soft magnetic materials, e.g., magnetic cantilever beams or magnetic beads, attached on or embedded in a flexible elastic membrane, and deflection of the membrane is created by a magnetic field generated by a nearby magnet. Similarly, an electromagnetic microvalve utilizes electrical energy to generate an electromagnetic field, which displaces or deflects the membrane. Gas actuation valves include pneumatic microvalves, which require an external system to pump air into or out of the system to deflect a membrane for valve opening and closing, and thermopneumatic microvalves actuate valving motion using a heating element and air expansion caused by increased temperatures.

The body size of microfluidics chips, especially for multiplexing applications requiring large numbers of reaction chambers, is subject to physical spatial constraints, and it can be challenging to build relatively bulky mechanical, optical, or magnetic microvalves for each reaction chamber on a chip. Moreover, microfluidics chips are typically manufactured from a select number of materials that allow optical transparency and biocompatibility. These materials may be different from the materials used to manufacture conventional microvalves, and interfacing the microvalves on the body of the chips can be difficult.

### SUMMARY

There accordingly is a need in the art for apparatuses and methods to efficiently load and distribute a fluidic sample into a microfluidic chip defining an integrated microfluidic network for multiplexing of isolated and independent reactions, diagnoses, and/or product production within the microfluidic network. To address this need, some of the present microfluidic chips utilize a valving mechanism comprising a crosslinkable material that, upon activation, hardens to seal off one or more first portions of the microfluidic network from one or more second portions of the network.

The microfluidic chip can include at least one port in fluid communication with one or more test volumes via one or more channels through which fluid must flow from the port to the test volume(s). In addition to the fluid, the microfluidic chip can comprise a crosslinkable (e.g., photo-crosslinkable and/or thermally-crosslinkable) material disposed within the microfluidic network of the chip that can also be flowable from the port to the test volume(s) through the channel(s).

The microfluidic chip can be loaded by flowing each of one or more portions of the liquid from the port, through at least one of the channel(s), and into a respective one of the test volume(s). Loading the microfluidic chip can further comprise directing the crosslinkable material into the channel(s). Once the crosslinkable material is directed into the channel(s) of the fluidic network, the crosslinkable material can be cross-linked in the channel(s) such that the test volume(s) are no longer in fluid communication with the port when the portion(s) of the liquid are in the test volume(s). The cross-linked material can thus occlude the channel(s) and prevent fluid flow to and from the test volume(s) other than that which occurs along one or more flow paths in the microfluidic network occurring post-occlusion by the cross-linked material, thereby isolating the test volume(s) from at least a portion of the microfluidic network. This can facilitate restriction of a reagent introduced into the microfluidic network to individual portion(s) of the liquid and can allow simultaneous and separate introduction of multiple reagents to multiple individual portions of the liquid.

Because the crosslinkable material can be seamlessly integrated with the microfluidic network body in a manner that is compatible with biological and chemical reactions, multiplexing applications can be simpler and more efficient. No extra space on the microfluidic network body or interfacing between the microfluidic chip and the valving mechanism is required to implement a valving mechanism within the fluidic network, and the equipment needed to activate the crosslinkable material (e.g., UV/visible light illumination or heat) is cheaper and easier to manage and operate than physical valves. Additionally, valving in the network is not constrained to a discrete location of a physical valve, and instead, actuation of a valving mechanism can occur at any location in the microfluidic network that is in fluid communication with the network channel(s).

Some of the present microfluidic chips include a microfluidic network that includes a port, one or more test volumes, and one or more channels through which fluid must flow from the port to the test volume(s). In some embodiments, the one or more test volumes comprise two or more test volumes, and the microfluidic network includes, for each of the test volume(s), a chamber through which fluid must flow before entering the test volume. The chambers, in some embodiments, have a maximum transverse dimension of less than or equal to 2 millimeters. Additionally, in some embodiments, each of the chamber(s) contains a reagent.

The microfluidic network, in some embodiments, includes, for each of the test volume(s), a droplet-generating region configured to produce droplets from liquid received by the droplet-generating region from the port such that the droplets flow into the test volume.

In some embodiments, a crosslinkable material is disposed within the microfluidic network such that the crosslinkable material is flowable through the channel(s). The crosslinkable material, in some embodiments, comprises a photo-crosslinkable and/or a thermally-crosslinkable material. The crosslinkable material, in some embodiments, comprises a monomer, a cross-linker, and an initiator. In some embodiments, the monomer comprises poly(dimethylsiloxane) monomethacrylate terminated, 3-[trist(trimethylsiloxy)sily]propyl methacrylate, and/or 2,2,3,3,4,4,5,5,6,6,7,7-dodecafluoroheptyl acrylate. In some embodiments, the cross-linker comprises polydimethylsiloxane-diacrylamide, poly(propylene glycol) diacrylate, poly(propylene glycol) dimethacrylate, ethylene glycol dimethacrylate, 2,2,3,3,4,4,5,5-octafluoro-1,6-hexyl diacrylate. In some embodiments, the initiator comprises 2-hydroxy-4′-(2-hydroxyethoxy)-2-methylpropiophenone, diphenyl(2,4,6-trimethylbenzoyl)phosphine oxide, 1-hydroxycyclohexyl phenyl ketone, and/or Eosin-Y.

Some of the present methods comprise exposing the crosslinkable material of a microfluidic chip disclosed herein to UV/visible light and/or heat to crosslink the material within. In some methods, crosslinking the crosslinkable material thereby occludes the channel(s).

Some of the present methods of loading a microfluidic chip comprise disposing a liquid within a port of a microfluidic network. In some methods, the microfluidic network includes one or more test volumes and one or more channels, one or more portions of the liquid is flowed from the port, through at least one of the channel(s), and into a respective one of the test volume(s). The one or more test volume(s), in some methods, comprise two or more test volumes. The one or more portions of the liquid, in some methods, comprise two or more portions of the liquid. In some methods, a reagent is introduced into each of the portion(s) of the liquid. The liquid, in some methods, comprises an aqueous liquid.

In some methods, the microfluidic network further includes, for each of the test volume(s), a chamber through which fluid must flow before entering the test volume. The chambers, in some methods, have a maximum transverse dimension of that is less than or equal to 2 millimeters.

In some methods, the microfluidic network further includes, for each of the test volume(s), a droplet-generating region. For each portion(s) of the liquid, in some methods, the flowing is performed such that the portion flows through a respective one of the droplet-generating region(s) to produce droplets. In some methods, the droplets flow into the test volume.

In some methods, a crosslinkable material is directed into at least one of the channel(s). The crosslinkable material, in some methods, is cross-linked such that none of the test volume(s) are in fluid communication with the port when the portion(s) of the liquid are in the test volume(s). In some methods, directing and cross-linking the crosslinkable material is performed such that none of the test volumes are in fluid communication with any other of the test volumes when the portions of the liquid are in the test volumes. In some methods, directing the crosslinkable material comprises directing the crosslinkable material from the port and into at least one of the channel(s). Before the flowing of the one or more portions of the liquid, in some methods, the crosslinkable material is disposed on the liquid in the port. In some methods, the cross-linking is performed before a portion of the liquid flows into one of the test volume(s).

The crosslinkable material, in some methods, comprises a photo-crosslinkable and/or a thermally-crosslinkable material. In some methods, a density of the crosslinkable material is less than a density of the liquid. The crosslinkable material, in some methods, comprises a monomer, a cross-linker, and an initiator. In some methods, the monomer comprises poly(dimethylsiloxane) monomethacrylate terminated, 3-[trist(trimethylsiloxy)sily]propyl methacrylate, and/or 2,2,3,3,4,4,5,5,6,6,7,7-dodecafluoroheptyl acrylate. In some methods, the cross-linker comprises polydimethylsiloxane-diacrylamide, poly(propylene glycol) diacrylate, poly(propylene glycol) dimethacrylate, ethylene glycol dimethacrylate, 2,2,3,3,4,4,5,5-octafluoro-1,6-hexyl diacrylate. In some methods, the initiator comprises 2-hydroxy-4′-(2-hydroxyethoxy) methylpropiophenone, diphenyl(2,4,6-trimethylbenzoyl)phosphine oxide, and/or 1-hydroxycyclohexyl phenyl ketone.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent.

The terms “comprise” and any form thereof such as “comprises” and “comprising,” “have” and any form thereof such as “has” and “having,” “include” and any form thereof such as “includes” and “including,” and “contain” and any form thereof such as “contains” and “containing,” are open-ended linking verbs. As a result, an apparatus that “comprises,” “has,” “includes,” or “contains” one or more elements possesses or contains those one or more elements, but is not limited to possessing or containing only those elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Further, a device or system that is configured in a certain way is configured in at least that way, but it can also be configured in other ways than those specifically described.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. Views in the figures are drawn to scale, unless otherwise noted, meaning the sizes of the depicted elements are accurate relative to each other for at least the embodiment in the view.

FIG. 1A is a sectional view of a port of a microfluidic network of one of the present microfluidic chips taken along line 1A-1A of FIG. 1B. The microfluidic chip is loaded with one or more liquids, reagents, and/or cross-linkable materials via, for example, the port and can be used in multiplexing applications.

FIG. 1B is a bottom view of a portion of the FIG. 1A microfluidic network and illustrates a droplet-generating region and test volume thereof.

FIG. 1C is a sectional view of the FIG. 1A microfluidic network taken along line 1C-1C of FIG. 1B and illustrates the droplet-generating region thereof.

FIG. 2A is a sectional view of the FIG. 1A microfluidic network with an aqueous sample liquid and a crosslinkable material disposed in the port thereof.

FIG. 2B is a bottom view of a portion of the FIG. 1A microfluidic network and illustrates the flow of sample from the port, through at least one channel of the microfluidic network, and into a respective test volume of the microfluidic network.

FIG. 2C is a sectional view of the FIG. 1A microfluidic network and illustrates droplet formation in the network's droplet-generating region.

FIG. 2D is a bottom view of a portion of the FIG. 1A microfluidic network and illustrates aqueous liquid and crosslinkable material disposed in the channel(s) of the network and also shows a suitable location for the cross-linkable material after cross-linking.

FIGS. 3A-3B are overlapped fluorescent and brightfield images of droplets in a test volume of the microfluidic network generated with (FIG. 3A) and without (FIG. 3B) a fluorescent dye reagent flowed into the network.

FIG. 4 is the averaged fluorescent intensity of droplets in test volumes of the microfluidic network into which fluorescent dye reagent was injected (droplet containers 1, 3, 5, 7, 10, 12, 14, and 16) compared to the averaged fluorescent intensity of droplets in test volumes of the microfluidic network into which fluorescent dye reagent was not injected (droplet containers 2, 4, 6, 8, 9, 11, 13, and 15).

FIG. 5A illustrates schematically a biocompatibility test of the crosslinkable material. Shown in (a) (left panel) is a comparison of configurations for testing the biocompatibility of the crosslinkable material in the microfluidic network (left image) and a 96-well plate (right image) in which the crosslinkable material is disposed atop an aqueous liquid. Shown in (b) (right panel) is an experimental 96-well plate layout for testing the effects of disposing a solution comprising Tris buffer and variable concentrations of a crosslinkable material atop aqueous bacterial solutions on subsequent bacterial culture. Test bacterial strains, organized by row, include the following: Rows A and E: control (no bacterial solution); Rows B and F: Klebsiella pneumoniae 87; Rows C and G: Pseudomonas aeruginosa 262; and Rows D and H: Staphylococcus aureus 29213. Test crosslinkable material solutions, organized by row and column, include the following: Rows A-D, Columns 1-3: Tris buffer; Rows A-D, Columns 4-6: Tris buffer+10 mg/mL crosslinkable material; Rows A-D, Columns 7-9: Tris buffer+20 mg/mL crosslinkable material; Rows A-D, Columns 10-12: Tris buffer+40 mg/mL crosslinkable material; Rows E-H, Columns 1-3: control (no Tris buffer or crosslinkable material).

FIG. 5B provides colorimetric results corresponding to bacterial cell viability after 24 hours' culture of the 96-well plate described for part (b) of FIG. 5A.

### DETAILED DESCRIPTION

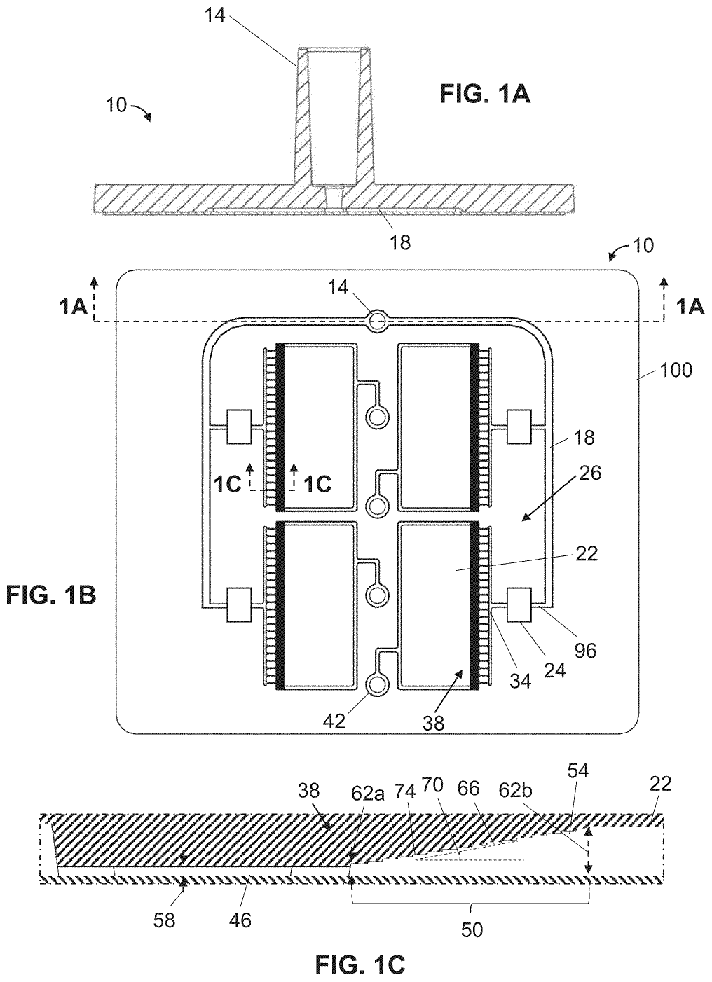

Referring to FIGS. 1A-1C, shown is an embodiment 10 of a microfluidic network of one of the present microfluidic chips 100 for loading one or more liquids, reagents, and/or cross-linkable materials for use in multiplexing applications. Network 10 can include a port 14 that can receive a liquid sample for analysis. Network 10 can also include one or more test volumes 22, such as greater than or equal to any one of, or between any two of, 2, 3, 4, 6, 8, 10, 12, 14, 16, 20, 24, 28, or 32 test volumes, and one or more channels 18, such as greater than or equal to any one of, or between any two of, 1, 2, 3, 4, 5, 6, 7, or 8 channels. As shown in FIG. 1B, the network includes four test volumes 22 and two channels branching laterally from each side of the port 14. As described in further detail below, each channel 18 can be configured such that sample introduced into port 14 flows along flow path 26 into a test volume 22 in which the interaction between the sample and a reagent can be analyzed.

Referring still to FIG. 1B—which shows a bottom view of a portion of network 10—each microfluidic network can further include one or more chambers 30 through which sample flows before entering the test volume(s) 22. At least one of the chamber(s) contains a reagent. To permit analysis of multiple reagents, network 10 can have multiple chambers 30—whether part of a single network or part of multiple networks-such as greater than or equal to any one of, or between any two of, 2, 3, 4, 6, 8, 10, 12, 14, 16, 20, 24, 28, or 32 chambers. For example, in the embodiment shown, the network 10 has four chambers 30. At least one of the chamber(s) 30 can omit a reagent (e.g., such that a control analysis can be performed), and other ones of the chambers can have different reagents. The chamber(s) 30 may have any suitable maximum transverse dimension to facilitate microfluidic flow, such as, for example, a maximum transverse dimension that is less than or equal to any one of, or between any two of, 2,000, 1,500, 1,000, 500, 300, 200, 100, 50, or 25 μm.

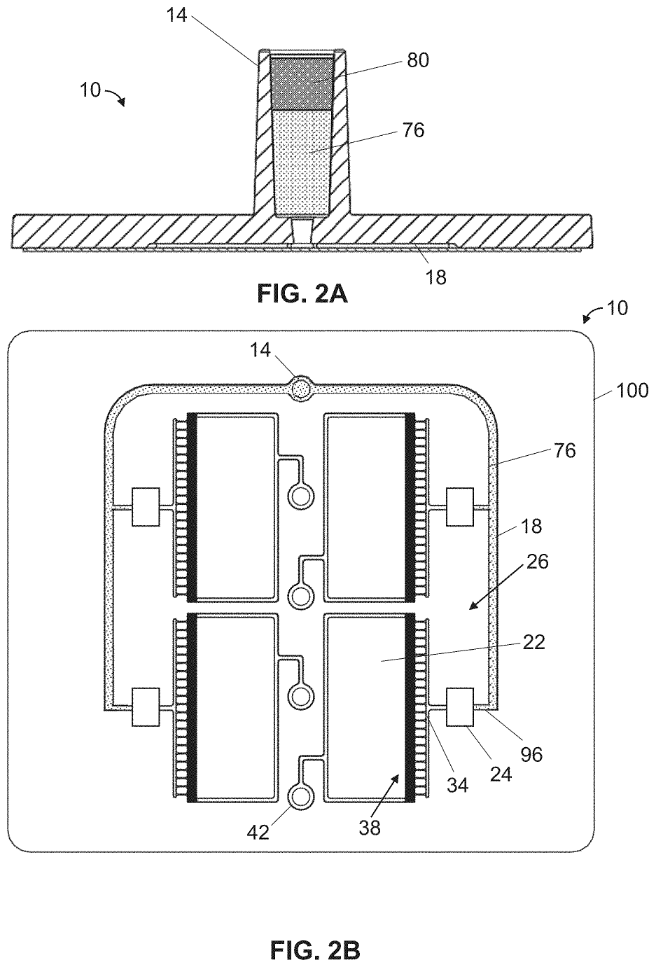

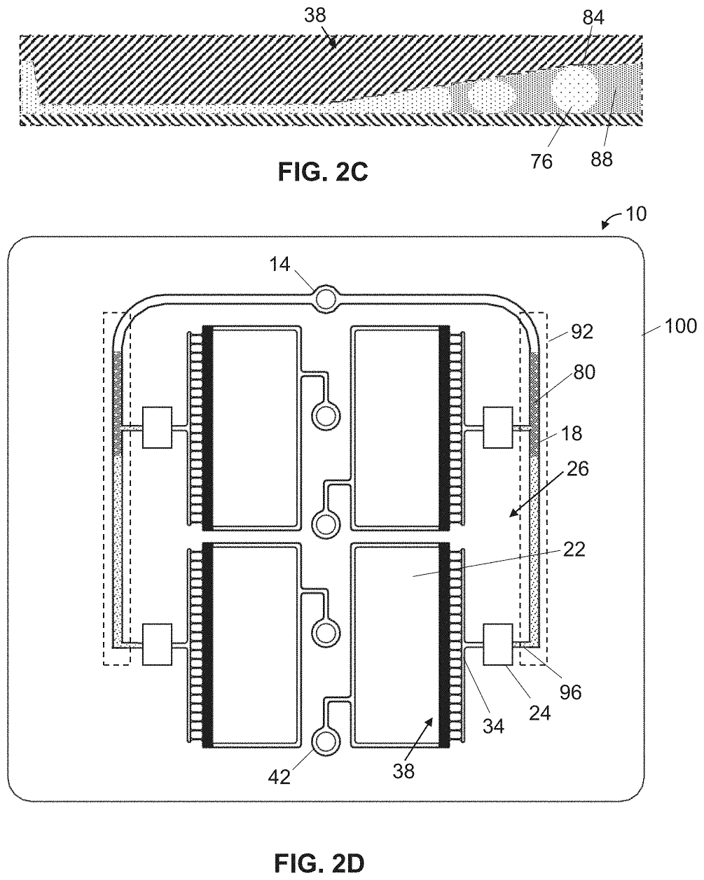

The microfluidic network 10 can also include a crosslinkable material 80 (e.g., a photo-crosslinkable and/or thermally-crosslinkable material) disposed within the network 10, as shown in FIGS. 2A-2B. The crosslinkable material 80 can be flowable through channel(s) 18 along flow path 26 and can be crosslinked to form a permanent occlusion in channel(s) 18, thereby facilitating the separate and independent analysis of multiple reagents in multiple chambers 30, such as greater than or equal to any one of, or between any two of, 2, 3, 4, 6, 8, 10, 12, 14, 16, 20, 24, 28, or 32 reagents and/or chambers.

The crosslinkable material used for in situ crosslinking within network 10 can comprise a monomer, a cross-linker, and an initiator. The monomer can be, e.g., poly(dimethylsiloxane) monomethacrylate terminated, 3-[trist(trimethylsiloxy)sily]propyl methacrylate, and/or 2,2,3,3,4,4,5,5,6,6,7,7-dodecafluoroheptyl acrylate. The cross-linker can be, e.g., polydimethylsiloxane-diacrylamide, poly(propylene glycol) diacrylate, poly(propylene glycol) dimethacrylate, ethylene glycol dimethacrylate, 2,2,3,3,4,4,5,5-octafluoro-1,6-hexyl diacrylate. The initiator can be, e.g., a photo-initiator and/or thermo-initiator, configured to cure, or harden, upon activation by ultraviolet and/or visible light and/or heat, respectively. A photo-initiator can be, e.g., 2-hydroxy-4′-(2-hydroxyethoxy)-2-methylpropiophenone, diphenyl(2,4,6-trimethylbenzoyl)phosphine oxide, and/or 1-hydroxycyclohexyl phenyl ketone. Any combination of these monomers, cross-linkers, and initiators may be used to produce the crosslinkable material 80.

Like liquid sample 76, crosslinkable material 80 can be received by port 14 of network 10. In some cases, crosslinkable material 80 has a density that is less than a density of a liquid sample 76, e.g., a specific gravity of the crosslinkable material can be less than or equal to any one of, or between any two of, 0.3, 0.4, 0.5, 0.6, 0.7, 0.8, or 0.9 g/cm³ (e.g., less than or equal to 0.5 g/cm³) and is immiscible with liquid sample 76. In such cases, crosslinkable material 80 can be disposed on the liquid sample in port 14, as shown in FIG. 2A, and flowable through channel(s) 18 along flow path 26 behind sample 76, as shown in FIG. 2D.

To allow each reagent to be introduced to a sample, each chamber 30 can be in fluid communication with at least one port 14 of the network 10, as shown in FIGS. 1A-1B. Such fluid communication can be achieved via a flow path 26 that extends between port 14 and chamber 30. As shown, for example, flow path 26 can include port 14 (FIG. 1A) to receive sample. Flow path 26 can further comprise one or more channels 18 that extend between port 14 and passageway 96 through which fluid can enter chamber 30 (FIG. 1B). To illustrate, for each microfluidic network 10, a portion of liquid sample from a port 14 can flow through channel(s) 18, and, for each chamber 30, through passageway 96 and into the chamber (FIGS. 2A-2B).

Each chamber 30 can be defined by a body coupled to microfluidic chip 100. The body can comprise an interior volume that includes chamber 30. An end of body can define an opening that is in communication with the interior volume and can receive or be received by an inlet port of chip 100. When coupled to the chip inlet port, the body can also define passageway 96 which, as described above, allows sample liquid from one of network 10's channel(s) 18 to enter chamber 30 (e.g., without flowing out of the chip inlet port) to contact a reagent, if present, in the chamber. The components and configuration thereof of a representative chamber 30 is described in, for example, U.S. Provisional Patent Application No. 63/227,303, incorporated by reference herein in its entirety.

The chip inlet port can define a reservoir that can be configured to receive sample liquid from chamber 30 and can contain a non-aqueous liquid (e.g., 88) for droplet generation. The sample, once loaded with reagent, can enter the reservoir and be directed into one of network 10's test volume(s) 22 for analysis.

Referring additionally to FIGS. 1B and 1C, each microfluidic network 10 can have, for each of its chamber(s) 30, a testing portion that includes the reservoir (e.g., defined by a chip inlet port), test volume 22, and one or more flow paths 34 extending between the reservoir and the test volume. Each flow path 34 can include a droplet-generating region 38 and, along the flow path 34, fluid can flow from the reservoir, through the droplet-generating region 38, and to test volume 22 such that droplets are formed and introduced into the test volume for analysis. Each flow path 34 can be defined by one or more channels and/or other passageways through which fluid can flow, and can have any suitable maximum transverse dimension to facilitate microfluidic flow, such as, for example, a maximum transverse dimension, taken perpendicularly to the centerline of the flow path 34, that is less than or equal to any one of, or between any two of, 2,000, 1,500, 1,000, 500, 300, 200, 100, 50, or 25 μm. Each testing portion of each microfluidic network 10 optionally includes an outlet port 42 that at least some (e.g., excess) droplets can enter from test volume 22; the outlet port 42 can be sealed to prevent fluid from entering or exiting the outlet port except via the flow path(s) between the outlet port and the test volume.

Droplet generation can be achieved in any suitable manner. For example, as shown in FIG. 1C, in droplet-generating region 38, a minimum cross-sectional area of flow path 34 can increase along the flow path in a direction away from the reservoir. To illustrate, flow path 34 can include a constricting section 46 and an expansion region 50, where a minimum cross-sectional area of the flow path is larger in the expansion region than in the constricting section. As such, liquid including aqueous sample in the presence of a non-aqueous liquid can expand to form droplets when it flows along flow path 34 from constricting section 46 to expansion region 50.

Such a change in the cross-sectional area of flow path 34 can result from variations in the depth of the flow path. For example, in expansion region 50, flow path 34 can include a constant section (e.g., along which the depth of the flow path is substantially the same) and/or an expanding section (e.g., along which the depth of the flow path increases along the flow path), a maximum depth 62b of each being larger than-such as at least 10%, 50%, 100%, 150%, 200%, 250%, or 400% larger than-constricting section 46's maximum depth 58. To illustrate, constricting section 46's maximum depth 58 can be less than or equal to any one of, or between any two of, 20, 15, 10, or 5 μm (e.g., between 10 and 20 μm) and expansion region 50's maximum depth 62b can be greater than or equal to any one of, or between any two of, 15, 30, 45, 60, 75, 90, 105, or 120 μm (e.g., between 65 and 85 μm).

As shown, expansion region 50 comprises an expanding section including a ramp 54 having a slope 66 that is angularly disposed relative to constricting section 46 by an angle 70 such that the depth of the expanding section increases moving away from the constricting section (e.g., from minimum depth 62a to maximum depth 62b). Angle 70 can be greater than or equal to any one of, or between any two of, 5°, 10°, 20°, 30°, 40°, 50°, 60°, 70°, or 80° (e.g., between 20° and 40°), as measured relative to a direction parallel to the centerline of constricting section 46. As shown, ramp 54 is defined by a plurality of steps 74 having a rise and run such that the ramp has any of the above-described slopes 66; in other embodiments, however, the ramp can be defined by a single, planar surface.

Droplet-generating region 38 can have other configurations to form droplets. For example, in other embodiments expansion of liquid can be achieved with a constant section alone, a constant section upstream of an expanding section, or an expanding section upstream of a constant section. And in other embodiments droplet-generating region 38 can be configured to form droplets via a T-junction (e.g., at which two channels-aqueous liquid flowing through one and non-aqueous liquid flowing through the other-connect such that the non-aqueous liquid shears the aqueous liquid to form droplets), flow focusing, co-flow, and/or the like. In some of such alternative embodiments, each of microfluidic network(s) 10 can include multiple chip inlet ports, and aqueous and non-aqueous liquids can be received in different inlet ports (e.g., such that they can meet at a junction for droplet generation).

Due at least in part to the geometry of droplet-generating region 38, droplets generated therein can have a relatively low volume, such as, for example, a volume that is less than or equal to any one of, or between any two of, 10,000, 5,000, 1,000, 500, 400, 300, 200, 100, 75, or 25 picoliters (pL) (e.g., between 25 and 500 pL). Each droplet can have, for example, a diameter that is less than or equal to any one of, or between any two of, 100, 95, 90, 85, 80, 75, 70, 65, or 60 μm (e.g., between 60 and 85 μm). The relatively low volume of droplets can facilitate analysis of, for example, microorganisms contained by the aqueous sample liquid. During droplet generation, each of one or more of the microorganisms can be encapsulated by one of the droplets (e.g., such that each of the encapsulating droplets includes a single microorganism and, optionally, progeny thereof). The concentration of encapsulated microorganism(s) in the droplets can be relatively high due to the small droplet volume, which may permit detection thereof without the need for a lengthy culture to propagate the microorganisms(s).

Droplets from droplet-generating region 38 can flow to test volume 22, which can have a droplet capacity that accommodates sufficient droplets for analysis. For example, test volume 22 can be sized to accommodate greater than or equal to any one of, or between any two of, 1,000, 5,000, 10,000, 20,000, 30,000, 40,000, 50,000, 60,000, 70,000, 80,000, 90,000, or 100,000 droplets (e.g., between 13,000 and 25,000 droplets). To do so, test volume 22 can have a length and width that are each large relative to its maximum depth, such as a length and width that are each at least 10, 20, 30, 40, 50, 60, 70, 80, 90, 100, 110, or 120 times as large as the test volume's maximum depth. By way of example, length and width can each be greater than or equal to any one of, or between any two of, 3, 4, 5, 6, 7, 8, 9, 10, 11, 12, 13, 14, 15, 16, or 17 mm; as shown, the length is larger than the width (e.g., the length is between 11 and 15 mm and the width is between 5 and 9 mm). Test volume 22's depth can accommodate droplets (e.g., without compressing the droplets) while mitigating droplet stacking. Its depth can be, for example, greater than or equal to any one of, or between any two of, 15, 30, 45, 60, 75, 90, 105, or 120 μm (e.g., between 15 and 90 μm, such as between 65 and 85 μm) (e.g., substantially the same as maximum depth 62b of expansion region 50) and, optionally, can be substantially the same across test volume 22.

Referring to FIGS. 2A-2D, to load a microfluidic network (e.g., 10) of a microfluidic chip (e.g., 100) (e.g., any of those described herein), some methods comprise disposing an aqueous liquid (e.g., 76) (e.g., a liquid containing a sample for analysis, such as urine, saliva, blood, soft tissue, mucus, and/or the like from a patient) within a port (e.g., 14) thereof. As described above, aqueous liquid within a port can flow into channel(s) (e.g., 18) of the network that are in fluid communication with the port (FIG. 2A-2B).

Some methods comprise introducing one or more—optionally two or more—reagents to the aqueous liquid, each of the reagent(s) contained within a respective one of one or more chamber(s) (e.g., 30) of the microfluidic device. For example, the aqueous liquid can contain one or more microorganisms, and each of the reagent(s) can comprise a drug such as an antibiotic (e.g., an antibacterial or an antifungal) such that the microfluidic chip can be used to assess the ability of the antibiotic(s) to kill or inhibit the growth of the microorganism(s). Vacuum loading can be used to introduce the reagent(s) to the aqueous liquid. With vacuum loading, some methods comprise reducing pressure at the port (e.g., 14) such that, for each of the chamber(s) (e.g., 30) in fluid communication with the port (e.g., 14), gas flows from the chamber and out of the port (e.g., through the aqueous liquid disposed therein). The pressure at the ports can be reduced below ambient pressure. For example, reducing pressure can be performed such that the pressure at the inlet port(s) is less than or equal to any one of, or between any two of, 0.5, 0.4, 0.3, 0.2, 0.1, or 0 atm. Greater pressure reductions can increase the amount of gas evacuated from each of the chamber(s).

Pressure at the port can then be increased (e.g., to ambient pressure) such that, for each of the chamber(s) in fluid communication with the port, at least a portion of the aqueous liquid flows from the port and into the chamber (FIG. 2B). For example, as described above, for each of the chamber(s), the portion of aqueous liquid can flow from the port (e.g., 14), along one or more channels (e.g., 18), and through a passageway (e.g., 96) into the chamber. By evacuating gas before introducing liquid into the chamber, pressure within the chamber can return to ambient pressure as liquid is introduced therein, allowing subsequent steps to be performed without the need for depressurization. In other embodiments, however, positive pressure loading can be used without gas evacuation (e.g., without reducing pressure at the port before pressure is increased at the port).

The portion of the aqueous liquid received in a reagent-containing chamber can completely fill the chamber and can contact the reagent in the chamber such that the aqueous liquid includes the reagent. When the device includes multiple chambers, at least one of the chamber(s) can omit a reagent such that a control experiment can be performed.

As shown, multiple chambers and test volumes can be loaded at the same time such that multiple reagents (e.g., multiple antibiotics) can be assessed along with a control. Some methods to do so comprise further loading a microfluidic network (e.g., 10) of a microfluidic chip (e.g., 100) (e.g., any of those described herein) with a crosslinkable material (e.g., 80) (e.g., a material comprising a monomer, a cross-linker, and an initiator, as described above) along with the aqueous sample within a port (e.g., 14) of the microfluidic network. As described above, like the aqueous sample, crosslinkable material within a port can be directed into channel(s) (e.g., 18) of the network that are in fluid communication with the port (FIG. 2A-2B). Directing the crosslinkable material can comprise directing the crosslinkable material from the port and into at least one of the channel(s). As illustrated by FIG. 2D, once directed into the channels of the network, the crosslinkable material can be crosslinked such that none of the test volume(s) (e.g., 22) are in fluid communication with the port when portion(s) of the liquid are in the test volume(s) (e.g., 92).

In some cases, the crosslinkable material is disposed on the aqueous liquid in the port and has a density less than a density of the liquid such that the crosslinkable material is flowed into the channel(s) after the aqueous liquid is flowed into the channels. After one or more portions of the aqueous liquid are loaded into and completely fill the chamber(s), the portion(s) of the aqueous liquid and the crosslinkable material flowing therebehind in the channel(s) interface at the entrance to the chamber(s) because the crosslinkable material may be immiscible with the aqueous liquid and does not enter the chamber(s) because the chamber(s) are filled with the aqueous liquid but instead remains in the channel(s) connecting the chambers. An activator, e.g., ultraviolet light, visible light, or heat, can be applied to crosslink the crosslinking material where it interfaces with the aqueous material at the entrance to the channel(s), thereby occluding the channel(s) (e.g., 92) (FIG. 2D). In some methods, the crosslinking is performed before a portion of the liquid flows into one of the test volume(s) but after a portion of the liquid flows into one of the chamber(s).

Localized occlusion of the channel(s) causes the chamber(s), which are typically in fluid communication with the network, to be sealed off from the network such that the chamber(s) are no longer in fluid communication with the port when portion(s) of the aqueous liquid are in the chamber(s). This permits the simultaneous assessment of multiple reagents in multiple chambers and test volumes with no interference, or crosstalk, between different reagents comprised in different chambers.

Some methods comprise, for each of the chamber(s), generating droplets of the aqueous liquid. Droplet generation can comprise, for each of the chamber(s), directing the aqueous liquid in the chamber to the reservoir containing the non-aqueous liquid. As with reagent introduction, droplet generation can be achieved through vacuum loading, and a method describing such droplet generation is described in, for example, U.S. Provisional Patent Application No. 63/227,303, incorporated by reference herein in its entirety. At least a portion of the aqueous liquid (e.g., 76) and at least a portion of the non-aqueous liquid (e.g., 88) flow from the reservoir and through the droplet-generating region (FIG. 2C). The aqueous liquid can form droplets (e.g., 76) when passing through the droplet-generating region, which can then enter a test volume (e.g., 22) for analysis. As described above, in the droplet-generating region, a flow path's minimum cross-sectional area can increase along the flow path in a direction away from the reservoir, which allows the aqueous liquid to form droplets in the presence of the non-aqueous liquid. To promote droplet generation, the non-aqueous liquid can be relatively dense compared to water, e.g., a specific gravity of the non-aqueous liquid can be greater than or equal to any one of, or between any two of, 1.3, 1.4, 1.5, 1.6, or 1.7 (e.g., greater than or equal to 1.5). With vacuum loading, as the aqueous and non-aqueous liquids enter the test volume, pressure within the test volume can increase until it reaches substantially ambient pressure.

Vacuum loading provides a number of benefits. In conventional loading techniques that use a positive pressure gradient, the test volume can be pressurized to above ambient pressure when loaded with droplets; as such, droplets loaded in that manner may tend to shift and evacuate from the test volume when the environment around the microfluidic chip returns to ambient pressure. To mitigate that evacuation, conventionally-loaded chips may need seals or other retention mechanisms to keep the droplets in the test volume and the pressure in the external environment may need to be returned to ambient pressure slowly. By achieving pressure equalization between the test volume and the environment outside of the microfluidic chip (e.g., to ambient pressure) using the negative pressure gradient, the position of the droplets within the test volume can be maintained for analysis without the need for additional seals or other retention mechanisms, and pressure equalization can be performed faster. Additionally, the negative pressure gradient used to load the microfluidic chip can reinforce seals (e.g., between different pieces thereof) to prevent delamination and can contain unintentional leaks by drawing gas into a leak if there is a failure. Leak containment can promote safety when, for example, the aqueous liquid includes pathogens. Nevertheless, in some embodiments droplet generation can be performed using a positive pressure gradient.

Once droplets are generated and disposed in the microfluidic device's test volume(s), some methods comprise, for each of the test volume(s), capturing an image of the liquid (e.g., droplets) within the test volume. The aqueous liquid can include a fluorescent compound, such as a viability indicator (e.g., resazurin, the active compound in ALAMARBLUE®) that can have a particular fluorescence that varies over time in the presence of a microorganism. In droplets that encapsulate a microorganism, for example, the microorganism may interact with the viability indicator to exhibit a fluorescent signature. The droplets can be illuminated with one or more light sources such that droplets can exhibit such fluorescence (if any), which can be measured using the image capture to assess the impact of the reagent introduced to the aqueous liquid. For example, an antibiotic may inhibit the growth of microorganism(s) encapsulated in the droplets; fewer droplets exhibiting a fluorescent signature relative to droplets in a control test volume may evidence the antibiotic's efficacy.

### EXAMPLES

The present invention will be described in greater detail by way of specific examples. The following examples are offered for illustrative purposes only and are not intended to limit the present invention in any manner. Those skilled in the art will readily recognize a variety of non-critical parameters that can be changed or modified to yield essentially the same results.

The isolation of chambers and test volumes within a microfluidic network using a crosslinkable material disclosed herein was demonstrated using an aqueous liquid comprising the fluorescent dye ALAMARBLUE®.

In a first experiment, a crosslinkable material was disposed on top of an aqueous liquid containing the fluorescent dye, and the crosslinkable material and aqueous liquid were introduced into a port of the microfluidic network, with the aqueous liquid entering the network prior to the crosslinkable material. The fluorescent fluid was flowed through a channel of the network into chambers of the network to fill the chambers, while flow of the crosslinkable material in the channel followed flow of the fluorescent fluid up to the chambers' entrance off the channel. The crosslinkable material was then activated (e.g., crosslinked) to occlude the channel at the chambers' entrance to prevent flow of the aqueous liquid containing the fluorescent dye out of the chambers and back into the channel. Then, using vacuum loading, the aqueous fluorescent dye-containing liquid was directed to non-aqueous liquid-containing reservoirs of the network, and droplet generation was achieved when a portion of the aqueous fluorescent dye-containing liquid and a portion of the non-aqueous liquid flowed through droplet-generating regions of the network. Finally, droplets containing the fluorescent dye were accumulated in test volumes of the network.

To observe flow of the aqueous fluorescent dye-containing liquid through the network and droplet accumulation in test volumes, time-lapse images were taken to visualize the liquid within the network. In all images captured, the aqueous fluorescent dye-containing liquid was entirely localized to individual chambers with no backflow of the fluorescent liquid into the channel (data not shown).

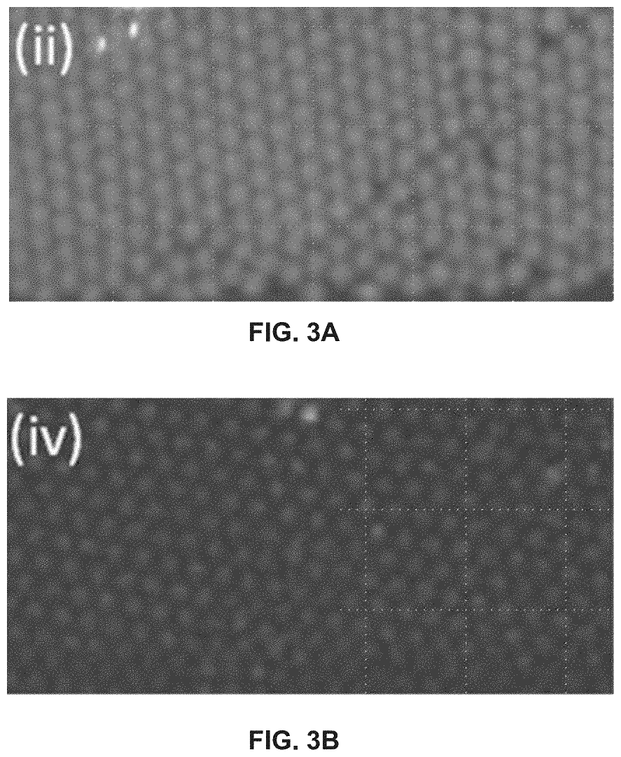

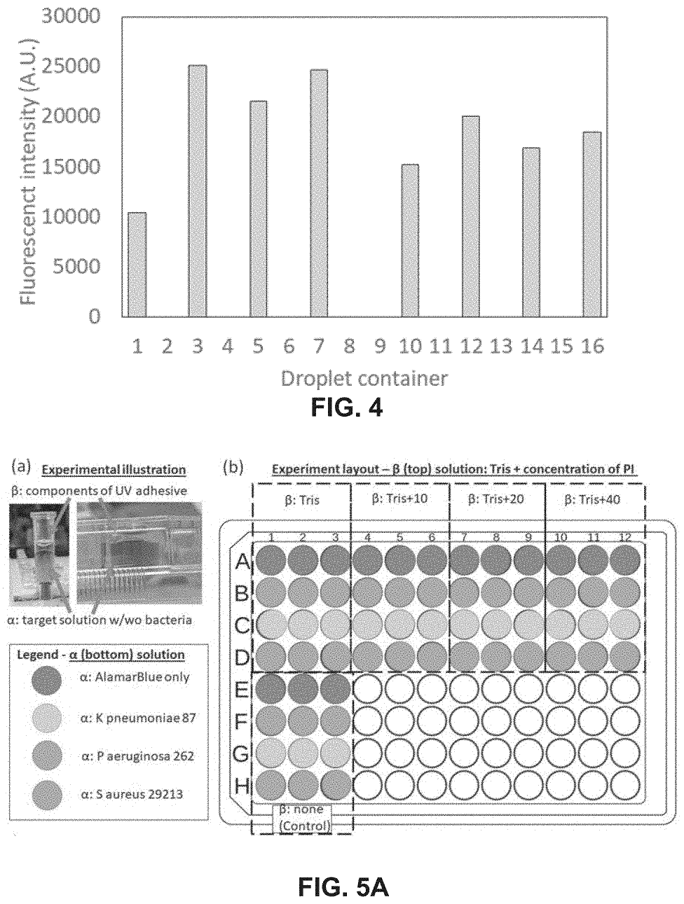

A second experiment was conducted in which concentrated fluorescent dye was instead injected into specific chambers of the network after loading of the network with an aqueous fluid without fluorescent dye; the second experiment was otherwise identical to the first experiment. Results from the second experiment are provided in FIGS. 3 and 4.

Droplets generated from chambers 1, 3, 5, 7, 10, 12, 14, and 16 of the network into which the fluorescent dye was injected exhibited strong fluorescent signal in overlapped fluorescent and brightfield images of the droplets collected in corresponding test volumes (FIG. 3A). In contrast, droplets generated from chambers 2, 4, 6, 8, 9, 11, 13, and 15 of the network into which the fluorescent dye was not injected had negligible fluorescent signal in overlapped fluorescent and brightfield images of the droplets collected in corresponding test volumes (FIG. 3B). FIG. 4 provides the averaged fluorescent intensity in an area of interest from all 16 test volumes to quantitatively show that the fluorescent dye did not pass from the chambers into which it was injected back into the network and into the chambers into which it was not injected. These results demonstrate that occlusion of the channel upon activation of the crosslinkable material can completely isolate chambers, test volumes, and the liquids therein from one another within the network, despite any stresses on the chambers and/or test volumes resulting from pressure changes or other mechanical forces exerted on the chambers and/or test volumes during droplet generation.

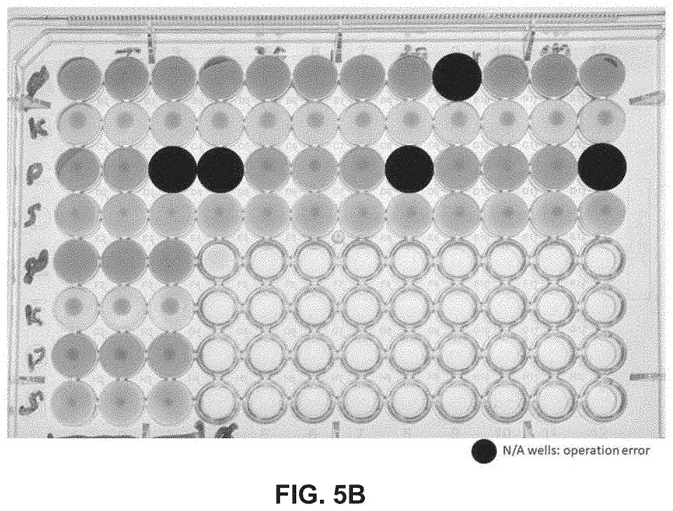

The capability of the crosslinkable material to be utilized for biological assays, reactions, and/or operations was demonstrated using culture of bacterial strains with the crosslinkable material in a 96-well plate. As shown in FIG. 5A (left panel), a crosslinkable material solution was disposed on top of an aqueous bacterial solution containing a fluorescent dye to simulate the conditions under which a comparable aqueous bacterial solution and crosslinkable material would be introduced at a port of a microfluidics network.

As illustrated by FIG. 5A (right panel), three bacterial solutions comprising three bacterial strains, culture medium, and ALAMARBLUE® for assaying bacterial cell viability were prepared and cultured in three replicates each. The bacteria in the bacterial solutions comprised Klebsiella pneumoniae 87 (rows A and E of the 96-well plate); Pseudomonas aeruginosa 262 (rows B and F of the 96-well plate); or Staphylococcus aureus 29213 (rows C and G of the 96-well plate). A solution comprising only ALAMARBLUE® was also included as a control (rows D and H of the 96-well plate).

Further illustrated by FIG. 5A (right panel), four crosslinkable material solutions comprising Tris buffer and increasing concentrations of the crosslinkable material were tested: Tris buffer+0 mg/mL crosslinkable material (rows A-D, columns 1-3 of the 96-well plate); Tris buffer+10 mg/mL crosslinkable material (rows A-D, columns 4-6 of the 96-well plate); Tris buffer+20 mg/mL crosslinkable material (rows A-D, columns 7-9 of the 96-well plate); and Tris buffer +40 mg/mL crosslinkable material (rows A-D, columns 10-12 of the 96-well plate). A solution comprising neither Tris buffer nor crosslinkable material was also included as a control (rows E-H, columns 1-3 of the 96-well plate).

After culture of the bacterial and crosslinkable solutions for 24 hours, a color image was taken of the 96-well plate to colorimetrically visualize bacterial cell viability (FIG. 5B). All wells containing the crosslinkable material exhibited the same color indicator and similarly-sized bacterial clusters as the controls for all three bacterial species, indicating that the crosslinkable materials do not impair bacterial growth and survival. These results suggest that the crosslinkable materials are compatible with biological samples and can be used in microfluidic applications without impeding biological assays, reactions, and/or operations.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A method of loading a microfluidic chip, the method comprising:
disposing a liquid within a port of a microfluidic network that includes:
one or more test volumes; and
one or more channels;
flowing each of one or more portions of the liquid from the port, through at least one of the channel(s), and into a respective one of the test volume(s); and
directing a photo-crosslinkable and/or thermally-crosslinkable material into at least one of the channel(s) and cross-linking the crosslinkable material such that none of the test volume(s) are in fluid communication with the port when the portion(s) of the liquid are in the test volume(s).

2. The method of claim 1, wherein:
the one or more test volumes comprise two or more test volumes;
the one or more portions of the liquid comprise two or more portions of the liquid; and
directing and cross-linking the crosslinkable material is performed such that none of the test volumes are in fluid communication with any other of the test volumes when the portions of the liquid are in the test volumes.

3. The method of claim 1, comprising introducing a reagent into each of the portion(s) of the liquid.

4. The method of claim 1, wherein directing the crosslinkable material comprises directing the crosslinkable material from the port and into at least one of the channel(s).

5. The method of claim 4, wherein before the flowing, the crosslinkable material is disposed on the liquid in the port.

6. The method of claim 1, wherein a density of the crosslinkable material is less than a density of the liquid.

7. The method of claim 1, wherein the cross-linking is performed before a portion of the liquid flows into one of the test volume(s).

8. The method of claim 1, wherein the microfluidic network includes, for each of the test volume(s), a chamber through which fluid must flow before entering the test volume.

9. The method of claim 1, wherein:
the microfluidic network includes, for each of the test volume(s), a droplet-generating region; and
the flowing is performed such that, for each of portion(s) of the liquid:
the portion flows through a respective one of the droplet-generating region(s) to produce droplets; and
the droplets flow into the test volume.

10. The method of claim 1, wherein the liquid comprises an aqueous liquid.

11. The method of claim 1, wherein the crosslinkable material comprises:
a monomer;
a cross-linker; and
an initiator.

12. The method of claim 11, wherein:
the monomer comprises poly(dimethylsiloxane) monomethacrylate terminated, 3-[trist(trimethylsiloxy)sily]propyl methacrylate, and/or 2,2,3,3,4,4,5,5,6,6,7,7-dodecafluoroheptyl acrylate;
the cross-linker comprises polydimethylsiloxane-diacrylamide, poly(propylene glycol) diacrylate, poly(propylene glycol) dimethacrylate, ethylene glycol dimethacrylate, 2,2,3,3,4,4,5,5-octafluoro-1,6-hexyl diacrylate; and
the initiator comprises 2-hydroxy-4′-(2-hydroxyethoxy)-2-methylpropiophenone, diphenyl(2,4,6-trimethylbenzoyl)phosphine oxide, and/or 1-hydroxycyclohexyl phenyl ketone.

13. A microfluidic chip defining a microfluidic network that includes:
a port;
one or more test volumes; and
one or more channels through which fluid must flow from the port to the test volume(s);
wherein a photo-crosslinkable and/or thermally-crosslinkable material is disposed within the microfluidic network such that the crosslinkable material is flowable through the channel(s).

14. The microfluidic chip of claim 13, wherein the one or more test volumes comprise two or more test volumes.

15. The microfluidic chip of claim 13, wherein the microfluidic network includes, for each of the test volume(s), a chamber through which fluid must flow before entering the test volume.

16. The microfluidic chamber of claim 15, wherein each of the chamber(s) contains a reagent.

17. The microfluidic chip of claim 13, wherein the microfluidic network includes, for each of the test volume(s), a droplet-generating region configured to produce droplets from liquid received by the droplet-generating region from the port such that the droplets flow into the test volume.

18. The microfluidic chip of claim 13, wherein the crosslinkable material comprises:
a monomer;
a cross-linker; and
an initiator.

19. The microfluidic chip of claim 18, wherein:
the monomer comprises poly(dimethylsiloxane) monomethacrylate terminated, 3-[trist(trimethylsiloxy)sily]propyl methacrylate, and/or 2,2,3,3,4,4,5,5,6,6,7,7-dodecafluoroheptyl acrylate;
the cross-linker comprises polydimethylsiloxane-diacrylamide, poly(propylene glycol) diacrylate, poly(propylene glycol) dimethacrylate, ethylene glycol dimethacrylate, 2,2,3,3,4,4,5,5-octafluoro-1,6-hexyl diacrylate; and
the initiator comprises 2-hydroxy-4′-(2-hydroxyethoxy)-2-methylpropiophenone, diphenyl(2,4,6-trimethylbenzoyl)phosphine oxide, and/or 1-hydroxycyclohexyl phenyl ketone.

20. A method comprising exposing the crosslinkable material of the microfluidic chip of claim 13 to light and/or heat to crosslink the material within and thereby occlude the channel(s).
